(19) United States
(12) Patent Application Publication
(10) Pub. No.: US 2007/0016312 A1
(43) Pub. Date: Jan. 18, 2007

(54) Methods, circuits, and computer program products for assigning identifiers to modules in uninterruptible power supply systems

(76) Inventors: Christian Gale Redmond, Raleigh, NC (US); Jonathan Aaron Rodriguez, Raleigh, NC (US)

Correspondence Address: Robert N. Crouse;Myers Bigel Sibley & Sajovec, P.A., Post Office Box 37428, Raleigh, NC, 27627, US

(21) Appl. No.: 11/183,130

(22) Filed: Jul. 15, 2005

(51) Int. Cl. G05B 11/01

(52) U.S. Cl. 700/22

(57) ABSTRACT

A method of assigning identifiers to modules in an Uninterruptible Power Supply (UPS) system can be provided by assigning UPS system module identifiers via sequential transmission of a signal between the UPS system modules. Related circuits are also disclosed.

### FIELD OF THE INVENTION

The invention relates to electrical power devices and methods of operation thereof, and more particularly, to uninterruptible power supply systems and methods of operation thereof.

### BACKGROUND

Uninterruptible Power Supply (UPS) systems are power conversion systems that are commonly used to provide conditioned, reliable power for devices and systems such as computer networks, telecommunications networks, medical equipment and the like. UPS systems can provide temporary power to the devices and systems so that the devices and systems can continue to operate despite the loss of the primary power source and thereby can reduce the likelihood that valuable data may be lost.

UPS systems may provide uninterrupted power by switching from a primary power source to a secondary power source if loss of the primary power source is detected. When the primary power source is restored, the UPS system may switch from the secondary power source back to the primary power source. Similarly, the UPS system may switch from the primary power source to the secondary power source if the UPS system determines that the primary power source is inappropriate. For example, if a voltage level of the primary power source is less than a minimum acceptable level, the UPS system may provide uninterrupted power by switching from the primary power source to the secondary power source.

Conventional UPS systems can include separate modules that provide respective functions to provide the overall operation of the UPS system. For example, some conventional UPS systems include separate modules such as rectifiers, inverters, batteries, and switches that cooperate to provide the overall function of the UPS systems. Moreover, the separate modules may need to communicate to provide the overall UPS system functions. For example, in some of the scenarios described above, a rectifier module may need to communicate the condition of the power provided by the primary power source so that the UPS system can determine whether to switch to the secondary power source.

Some conventional systems may use a network, such as a Controller Area Network (CAN), to communicate between modules in the system. One such system is discussed, for example, in U.S. Pat. No. 5,323,385 to Jurewicz et al., entitled Serial Bus Communication Method in a Refrigeration System. Some of these systems use identifiers to uniquely identify modules within the system. One conventional approach of providing unique identifiers to modules uses a customized connector for each module in the system that provides a unique set of signals to each. One type of customized connector is disclosed, for example, in U.S. Pat. No. 6,629,247, entitled Methods, Systems, and Computer Program Products for Communications in Uninterruptible Power Supply Systems Using Controller Area Networks, the content of which is incorporated herein by reference.

### SUMMARY

Embodiments according to the invention can provide methods, circuits, and computer program products for assigning identifiers to modules in uninterruptible power supply systems. Pursuant to these embodiments, a method of assigning identifiers to modules in an Uninterruptible Power Supply (UPS) system can be provided by assigning UPS system module identifiers via sequential transmission of a signal between the UPS system modules.

In some embodiments according to the invention, the method can further provide for transmitting the signal from a first module in the UPS system to a second UPS system module in the UPS system responsive to first UPS system module having a first module identifier assigned thereto. The signal is received at the second UPS system module to initiate a module identifier assignment process by the second module for assignment of a second module identifier thereto.

In some embodiments according to the invention, the signal is received at the second UPS system module after assignment of a temporary module identifier to the second UPS system module. In some embodiments according to the invention, module identifier information is requested by the second UPS system module from the first UPS system module via a Controller Area Network (CAN) coupled to the first and second UPS system modules using a temporary module identifier assigned to the second UPS system module. The requested module identifier information is transmitted including the second module identifier from the first UPS system module to the second UPS system module via the CAN.

In some embodiments according to the invention, the second module identifier is assigned to the second UPS system module to replace the temporary module identifier and a second signal is transmitted from the second UPS system module to another UPS system module. In some embodiments according to the invention, initialization information is transmitted from the first UPS system module to the second UPS system module via the CAN to provide information for operations of the second UPS system module.

In some embodiments according to the invention, module information associated with the second UPS system module, including module type, module revision, module software version, voltage meter values, frequency meter values, and/or power meter values, are transmitted to the first UPS system module via the CAN. In some embodiments according to the invention, a UPS system module map is defined at the first UPS system module based on the module information received thereat.

In some embodiments according to the invention, an acknowledgement is transmitted from the second UPS system module to the first UPS system module to confirm assignment of second module identifier to second UPS system module. In some embodiments according to the invention, module identifier information is updated at the first UPS system module to indicate assignment of second module identifier to second UPS system module. In some embodiments according to the invention, the UPS system module identifiers are physical locations of UPS system modules associated therewith.

A circuit for communication among modules in an Uninterruptible Power Supply (UPS) system includes a UPS system module assignment circuit included on a UPS system module. The UPS system module assignment circuit is configured to receive a signal from outside the UPS system module indicating start of a UPS system module identifier assignment process. A Controller Area Network (CAN) interface circuit is configured to transmit/receive CAN formatted messages including messages requesting module identifier information responsive to receipt of the signal.

In some embodiments according to the invention, the circuit includes a table configured to store a temporary module identifier, initialization information comprising initial operating parameters for the UPS system module, a module identifier received from a master UPS system module via the CAN, a module version, and/or a software version number. The UPS system module can be a dummy UPS system module.

In some embodiments according to the invention, the circuit also includes a table configured to store module identifier information comprising a plurality of module identifiers, and/or a UPS system module map including physical location information indicating respective positions of the UPS system modules assigned module identifiers.

### BRIEF DESCRIPTION OF THE DRAWINGS

FIG. 1 is a block diagram that illustrates a UPS system according to some embodiments of the invention.

FIG. 2. illustrates a conventional extended Controller Area Network (CAN) message frame format.

FIG. 3 is a block diagram that illustrates a UPS assignment circuit according to some embodiments of the invention.

FIG. 4 is a block diagram that illustrates a UPS assignment circuit associated with a master module according to some embodiments of the invention.

FIG. 5 is a timing diagram that illustrates CAN messages between a master module and another module in the UPS system during a module identifier assignment process according to some embodiments of the invention.

FIG. 6 is a flowchart that illustrates operations of UPS systems according to some embodiments of the invention.

### DESCRIPTION OF EMBODIMENTS ACCORDING TO THE INVENTION

The invention now will be described more fully hereinafter with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the described invention may be embodied as methods or devices. Accordingly, different aspects of the invention may take the form of a hardware embodiment, a software embodiment or an embodiment combining software and hardware aspects.

The invention is also described using a flowchart illustration and block diagrams. It will be understood that each block (of the flowchart and block diagrams), and combinations of blocks, can be implemented by computer program instructions. These program instructions may be provided to a processor(s), such as a microprocessor, microcontroller or other processor provided within an uninterruptible power supply system, such that the instructions which execute on the processor(s) create means for implementing the functions specified in the block or blocks. The computer program instructions may be executed by the processor(s) to cause a series of operational steps to be performed by the processor(s) to produce a computer implemented process such that the instructions which execute on the processor(s) provide steps for implementing the functions specified in the block or blocks.

Accordingly, the blocks support combinations of means for performing the specified functions, combinations of steps for performing the specified functions and program instruction means for performing the specified functions. It will also be understood that each block, and combinations of blocks, can be implemented by special purpose hardware-based systems which perform the specified functions or steps, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. Thus, a first element could be termed a second element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As described herein below in greater detail, in some embodiments according to the invention, the assignment of module identifiers in a UPS system can be provided by distributing a signal in a sequential fashion between the modules included therein. For example, a first stage can provide for transmission of a signal from a first UPS system module to a second UPS system module connected thereto. Upon receipt of the signal, the second UPS system module can carry out a module identifier assignment process whereby a master UPS system module can provide a module identifier to the second UPS system module. Furthermore, the second UPS system module can transmit another signal into the next stage so that the next UPS system module may initiate a module identifier assignment process in conjunction with the master UPS system module. This process can be carried out until all UPS system modules have been assigned module identifiers. As described hereinbelow in greater detail, module identifiers can be associated with the physical locations of the modules in the UPS system.

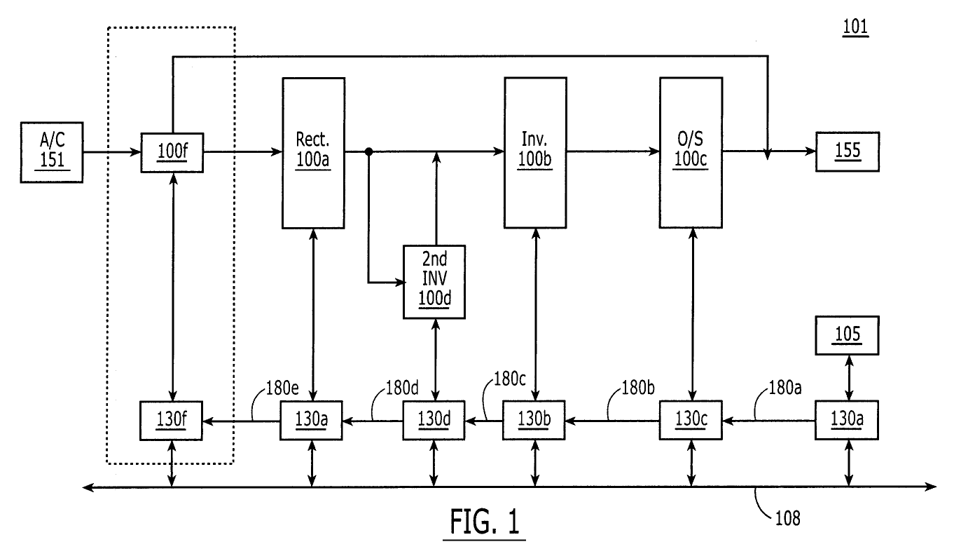

FIG. 1 is a block diagram that illustrates a UPS system 101 according to some embodiments of the invention. The UPS system 101 can provide AC power to a load 155 from a primary power source 151 or a secondary power source 100d. The primary power source 151 can be any source of AC power, such as a generator or a utility. The secondary power source 100d can be a battery, a generator, a capacitor, or other device that can be used to provide an alternative source of AC power to the load 155. The load 155 can be a system or device such as one or more computers. As used herein, “power” includes, but is not limited to, 3-phase or single phase electrical power that can be provided to a load. The term “power” can include power provided by Direct Current (DC) or Alternating Current (AC).

The UPS system 101 can operate in a normal mode or a bypass mode. In normal mode, the UPS system 101 can derive AC power from the primary power source 151 and provide the derived AC power to the load 155. For example, the UPS system 101 can derive AC power from the primary power source 151 by converting the AC power from the primary power source 151 to DC power and converting the DC power back to AC power which is provided to the load 155.

In bypass mode, the UPS system 101 can electrically couple the AC power from the primary power source 151 directly to the load 155. Bypass mode may be used, for example, to electrically isolate the UPS system 101 from the primary power source 151 and the load 155 when the UPS system 101 is being serviced.

According to FIG. 1, the UPS system 101 can operate under the control of a master UPS system module (i.e., master module) 105 that coordinates the operations of other UPS system modules (i.e., modules) in the UPS system 101 using communications over a Controller Area Network (CAN) 108. In particular, the master module 105 can communicate with the other modules in the UPS system 101 over the CAN 108 through module interface circuits 130a-f that electrically couple the respective modules to the CAN 108. Other modules can include a rectifier 100a, an inverter 100b, an output switch 100c, the secondary power source 100d, and the bypass switch 100f. The UPS system 101 can include other modules, and specifically, can include modules that are identical. For example, the UPS system 101 may include multiple inverter modules. The operations of these modules are well known and are, therefore, not discussed in detail herein.

The CAN 108 can be used, for example, to determine the condition of the AC power from the primary power source 151 and to switch from the primary power source 151 to the secondary power source 100d by transmitting and receiving CAN 108 messages in the UPS system 101. The master module 105 can transmit a command message to other modules in the UPS system 101 that request information or instruct a module to take specified action(s). For example, the master module 105 can turn the rectifier 100a on and off by transmitting respective on and off commands over the CAN 108 to the module interface circuit 130a. Accordingly, each module interface circuit 130a-f can determine the status or control the operations of its associated module.

It will be understood that each of the module interface circuits 130a-f can be separate from or part of the associated module. For example, the system control module 105 may include the module interface circuit 130e. For convenience, the term “module” is sometimes used to refer to the module and the associated module interface circuit as one unit. Furthermore, the module interface circuit can be associated with a “dummy” module that provides functionality so that the master module may communicate with the “dummy” and assign a module identifier thereto so that the physical locations of all other modules can be properly assigned in view of their respective locations within the UPS system 101.

Each of the UPS system modules 100a-f is assigned an associated module identifier that can indicate the physical location of the module in the UPS system 101. For example, the rectifier 100a may be assigned a module identifier that indicates a particular slot of the UPS system 101. Furthermore, the other modules have respective associated module identifiers that also indicate a unique physical location in the UPS system 101.

Referring to FIG. 1, the modules are coupled together in a serial fashion where each of the interconnects 180a-e represents a single stage in the serial transmission of the signal. The interconnect 180a represents a first stage so that a signal can be transmitted from the master module 105 to module 100c, which buffers the other modules (downstream) from receiving the signal until provided by the immediate upstream module. For example, module 100c can transmit the signal into the second stage (interconnect 180b) so that the inverter module 100b can receive the signal. Similarly, the other modules located downstream from the inverter module 100b receive the signal when the module in immediate preceding stage transmits the signal. As shown in FIG. 1, the sequential transmission terminates at the bypass switch module 100f. It will be understood that the signal is sequentially transmitted from module to module in the UPS system 101 so that each module can receive the signal initially transmitted by the master module 105.

In operation, each of the modules can perform a module identifier assignment process responsive to receiving the signal provided by interconnect 180a-f. During the assignment process, the respective module receiving the signal can request module identifier information from the master module 105 by transmitting a request message via the CAN 108. In response, the master module 105 can transmit a CAN message including the requested module identifier information to the requesting module. In some embodiments according to the invention, the module identifier information includes a module identifier that uniquely identifies the module within the UPS system 101. Furthermore, the module identifier can indicate a physical location of the module in the UPS system 101. In further embodiments according to the invention, the module identifier information includes initialization information to be used for initial operation of the module.

The module assigns the module identifier provided by the master module 105 to itself and uses the module identifier in subsequent communications via the CAN 108. Furthermore, the module transmits the signal into the next stage so that the module immediately downstream can initiate a module identifier assignment process responsive thereto. This process can be repeated according to the sequence provided by the interconnect 189a-e until each of the modules is assigned a module identifier by the master module 105.

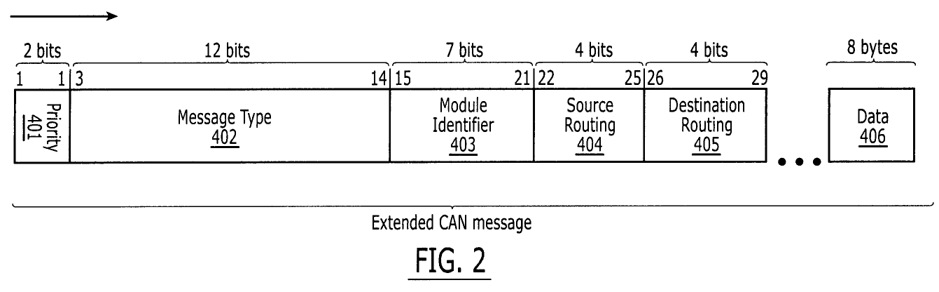

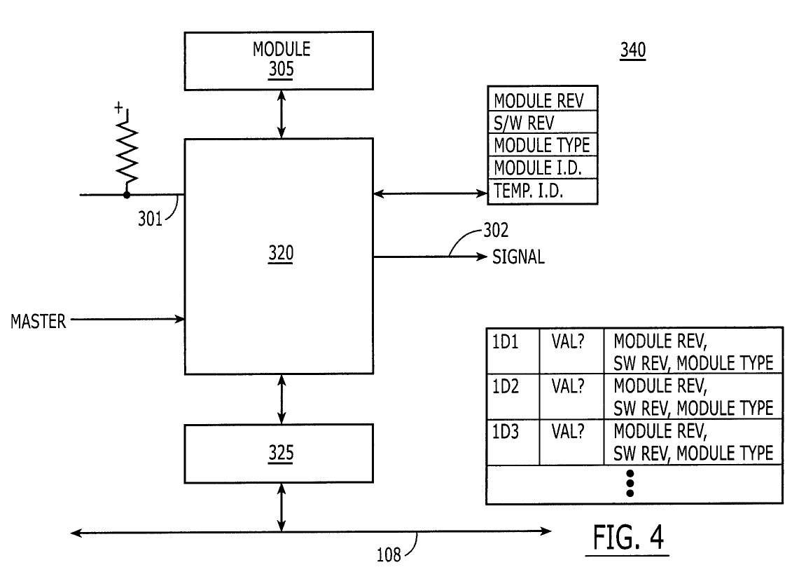

FIG. 2 is a diagram that illustrates extended CAN messages and data formats according to some embodiments of the invention. CAN messages can be transmitted over the CAN 108 using the CAN frame format shown in FIG. 4. In particular, a CAN message according to some embodiments of the invention can include a priority field 401, a message type field 402, a module identifier field 403, source and destination routing fields 404, 405, and a data fields 406.

The message type field 402 can include information that identifies what type of data is included in the CAN message according to the invention. The module identifier field 403 (bits 15-21) can identify the module in the UPS system 101 which transmitted the CAN message. The data fields 406 can include data for the module associated with the particular message, such as a module identifier to be assigned to the module. It will be understood that the CAN messages described herein can be provided by applying electronic signals to the modules in the UPS system in accordance with the CAN message frame formats. CAN message frame formats are further described, for example, in The Bosch CAN Specification, 1991 Robert Bosch Gmbh, Postfach 50, D-7000 Stuffgart 1 and in Controller Area Network (CAN), A Serial Bus System—Not Just For Vehicles, by ESD GMBH Hanover.

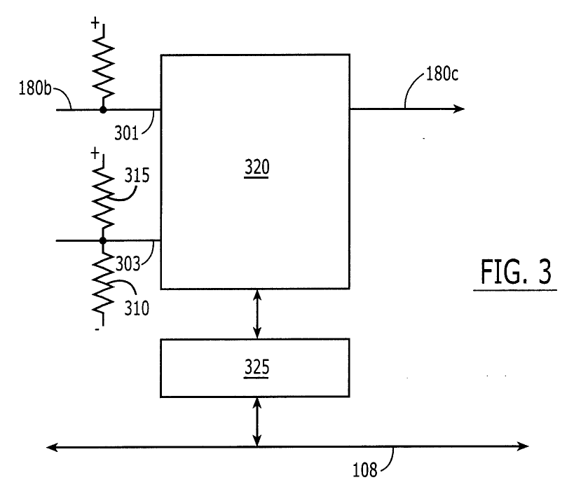

FIG. 3 is a block diagram of a UPS assignment circuit 320 according to some embodiments of the invention. It will be understood that the UPS assignment circuit 320 illustrated in FIG. 3 can be included with the module interface circuit 130 or be separate therefrom. For example, the UPS assignment circuit 320 and the module interface circuit 130 may be implemented as software/firmware in a microcontroller. Furthermore, the module interface circuit 130 may be integrated with the respective module or may be separate therefrom.

According to FIG. 3, an upstream stage 180b is connected to an input 301 of the (UPS assignment) circuit 320 that is configured to provide the module identifier assignment process for the associated module. In some embodiments according to the invention, the signal provided to the circuit 320 at input 301 is an active low signal which indicates that the circuit 320 is to initiate the module identifier assignment process when the signal is low. Accordingly, a pull-up resistor 305 can be used to maintain a high voltage level at the input 301 (i.e., in the off state) until the signal is received from the immediately preceding module.

The circuit 320 carries out the module identifier assignment process by requesting module identifier information from the master module 105 by transmitting and receiving messages over the CAN 108 via a CAN interface circuit 325 that is associated with the module. For example, the circuit 320 can transmit a request for module identifier information to the master module 105 using a temporary module identifier that is stored local to the module undergoing the module identifier assignment process. The master module 105 can respond by transmitting the requested module identifier information to the module using the temporary module identifier provided with the request. The circuit 320 can then assign the module identifier included with the module identifier information to the module.

The CAN interface circuit 325 can transmit information associated with the respective module in a CAN message via a CAN transceiver (not shown). The CAN transceiver can be a differential transceiver that transmits and receives data and commands at voltage levels appropriate for use in CAN systems. The CAN transceiver can be, for example, a 485-differential type transceiver marketed by Phillips Semiconductors, Inc.

The CAN interface circuit 325 can be implemented using a microcontroller, such as an ST10F167 marketed by ST Microelectronics, Inc. The microcontroller can be programmed with computer program code which carries out operations according to the embodiments of the invention. Moreover, the microcontroller can be reprogrammed to carry out different operations so that the module interface circuits 130 can be associated with any of the modules in the UPS system 101. For example, a module interface circuit 130 according to the invention can be programmed to be associated with the inverter module 10b or the rectifier module 100a.

The circuit 320 can forward the signal into the next stage 180c to the immediately following module. Accordingly, the immediately following module can perform a respective module identifier assignment process as outlined above.

In some embodiments according to the invention, an input 303 is provided to the circuit 320 to indicate whether the UPS assignment circuit 320 is associated with a module that is configured as the master module 105 within the UPS system 101. As shown in FIG. 3, the input 303 can be provided, for example, by installing a master switch 315. The master switch 315 can raise the voltage at the input 303 to a high level, which can indicate that the module associated with the UPS assignment circuit 320 is the master module. Otherwise, a pull down resistor 310 can maintain a low voltage level at the input 303, which can indicate that the module associated with the circuit 320 is not the master module 105. It will be understood that other configurations can be used to provide an indication of whether the module is configured as the master module 105 within the UPS system 101.

FIG. 4 is a block diagram that illustrates the UPS assignment circuit 320 associated with a module 305 in greater detail in some embodiments according to the invention. According to FIG. 4, a module information table 340 can be used to store information related to the module 305, such as the module revision number, the software revision number, the module type, the module identifier (once assigned), and a temporary module identifier that can be used in messages transmitted to the master module 105 requesting module identifier information. The module information table 340 may also store data related to operation of the module. For example, the table 340 can include voltage, current, frequency and/or power meter values associated with the module.

It will be further understood that the module information table 340 can also include initial parameters with which to initialize the module 305. The initial parameters may include, for example, on/off control, threshold value to limit the operation of the module 305 or subsystems thereon (such as temperature thresholds, voltage thresholds, current thresholds, etc.), and/or messages that include information passed between modules via the CAN 108.

A system map 345 can be associated with the circuit 320 when the module 305 is configured to be the master module 105 according to the voltage level at the input 303 of the circuit 320. In particular, the system map 345 can include a listing of module identifiers available for assignment to other modules in the UPS system 101, status information indicating whether an associated module identifier has already been assigned to a module, a listing of that module's information found in the table 340 (such as the module revision, the software revision, the module type, etc.), and/or module initialization parameters which may be provided to the modules with the module identifier information. The initial parameters provided to the modules can include, for example, limit thresholds described above in reference to the module information table 340. In operation, a module identification information included in the system map 345 can be transmitted to a requesting module during the module identifier assignment process described above.

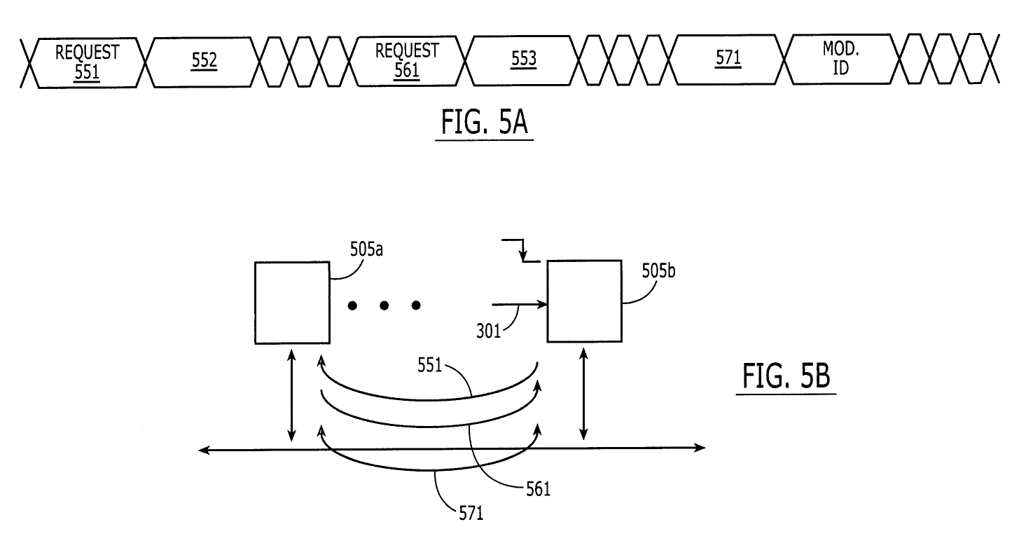

FIG. 5A is a timing diagram that illustrates the transmission/reception of messages during a module identifier assignment process conducted between a requesting module 505b and a master module 505a as also reflected in FIG. 5B. According to FIG. 5B, a signal 542 is received at the input 301 of module 505b indicating a module identifier assignment process is to begin. In response, module 505b transmits a request message 551 to the master module 505a according to the CAN frame format described above. The request message 551 includes a temporary module identifier 552 in the module identifier field 403.

The master module 505a receives the request message 551 and transmits a response message 561 including module identifier information 553 in the data field 406. The module identifier information 553 is the next unassigned module identifier in the system map 345 as described above in reference to FIG. 4. In particular, the module identifier information 553 transmitted to the module 505b can include a module identifier and initial parameters that can be loaded into the module 505b for initial operations thereof. Other information can also be included with the module identifier information. Module 505b loads the module identifier included in the module identifier information 553 into the module information table 340 described above in reference to FIG. 4. Furthermore, the module 505b can load the initial operating parameters provided with the module identifier information into the module information table 340 for initial operations of the module 505b.

In some embodiments according to the invention, a confirmation message 571 can be transmitted from the module 505b to the master module 505a (including the newly assigned module identifier in the module identifier field 403) to confirm that the module identifier assignment process has been successfully completed and that the module 505b is available for operations. In response, the master module 505a may load the information for module 505b into the system map 345.

The information included in the system map 345 may be used to evaluate the overall configuration of the UPS system 101. For example, the information included in the system map 345 can be compared to known valid UPS system configurations and/or compared to known invalid UPS system configurations to assist in the installation of new modules or systems in the field. Furthermore, information included in the system map 345 may be reported by the master module 505a to a remote console or diagnostic system for monitoring or diagnosis.

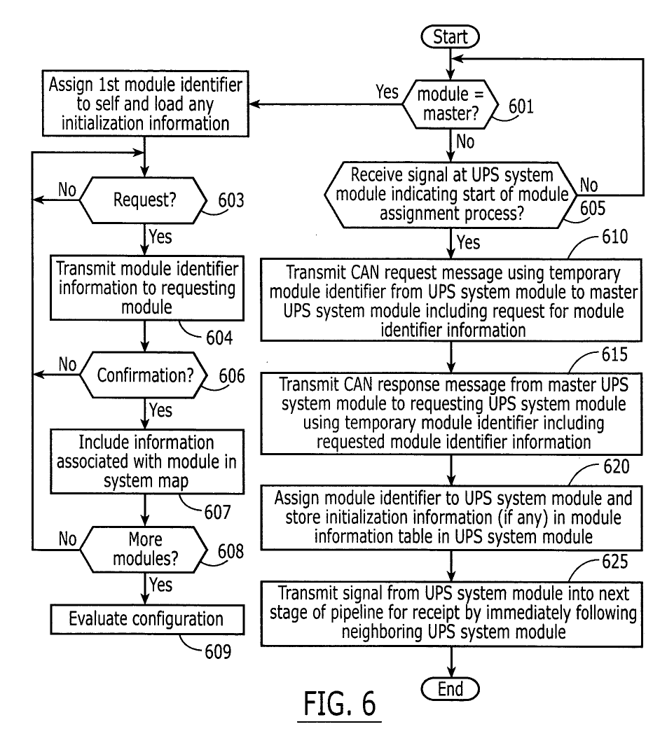

FIG. 6 is a flow chart that illustrates operations of UPS systems according to some embodiments of the invention. If the module is determined to be the master module (Block 601) by, for example, detecting the master switch, the module assigns the first module identifier from the system map to itself and loads any associated initialization information into the module information table associated therewith (Block 602). The master module awaits the receipt of request messages from other modules requesting module identifier information (block 603).

If, however, the module is determined not to be the master module (Block 601), the module awaits receipt of the signal from its immediately preceding neighboring module to initiate the module identifier assignment process (block 605). When the signal is received at the module from the immediately preceding module, a module assignment process is initiated by module (block 605). The module transmits a message to the master module requesting module identifier information via the CAN. In some embodiments according to the invention, the master module is assumed to have a predetermined module identifier associated therewith so that the modules transmitting the request messages can reliably communicate with the master module regardless of which module is configured as the master.

The message transmitted by the module includes a temporary module identifier in the module identifier field of the CAN message frame (Block 610). In response, the master module transmits a response message to the requesting module via the CAN. The response message from the master module includes the temporary module identifier used by the requesting module. Further, the response message includes the requested module identifier information, which can include a module identifier that can correspond to a physical location (e.g., a slot) in the UPS system and/or initialization information to be used for initial operation of the requesting module (Block 615).

The requesting module assigns the module identifier included in the response message to itself and stores any initialization information in the module information table associated with the module (Block 620). Upon completion of the module identifier assignment process, the module transmits a signal into the next stage for receipt by the immediately following module (Block 625). In some embodiments according to the invention, the module can also transmit a confirmation message to the master module via the CAN.

Referring again to block 603, when a request message is received, the master module transmits a response message to the requesting module including the requested module identifier information (block 604). The master module may also receive a confirmation message from the requesting module indicating that the module identifier assignment process has been successfully completed (block 606). Upon receipt of the confirmation message, the master module may include the information associated with the module having the newly assigned module identifier into the system map maintained therein (block 607). The process outlined above can be repeated for each of the modules included in the UPS system module (block 608) until all of the UPS system modules have been assigned module identifiers. The information included in the system map may be used to evaluate the configuration of the UPS system (block 609).

As described herein, in some embodiments according to the invention, the assignment of module identifiers in a UPS system can be provided by distributing a signal in a sequential fashion between the modules included therein. For example, a first stage can provide for transmission of a signal from a first UPS system module to a second UPS system module connected thereto. Upon receipt of the signal, the second UPS system module can carry out a module identifier assignment process whereby the a master UPS system module can provide a module identifier to the second UPS system module. Furthermore, the second UPS system module can transmit another signal into the next stage so that the next UPS system module may initiate a module identifier assignment process in conjunction with the master UPS system module. This process can be carried out until all UPS system modules have been assigned module identifiers, which can indicate physical locations of the modules within the UPS system.

Many alterations and modifications may be made by those having ordinary skill in the art, given the benefit of the present disclosure, without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

What is claimed:

1. A method of assigning identifiers to modules in an Uninterruptible Power Supply (UPS) system comprising:
assigning UPS system module identifiers via sequential transmission of a signal between the UPS system modules.

2. A method according to claim 1 wherein assigning further comprises:
transmitting the signal from a first module in the UPS system to a second UPS system module in the UPS system responsive to first UPS system module having a first module identifier assigned thereto; and
receiving the signal at the second UPS system module to initiate a module identifier assignment process by the second module for assignment of a second module identifier thereto.

3. A method according to claim 2 wherein the signal is received at the second UPS system module after assignment of a temporary module identifier to the second UPS system module.

4. A method according to claim 2 further comprising:
requesting module identifier information by the second UPS system module from the first UPS system module via a Controller Area Network (CAN) coupled to the first and second UPS system modules using a temporary module identifier assigned to the second UPS system module; and
transmitting the requested module identifier information including the second module identifier from the first UPS system module to the second UPS system module via the CAN.

5. A method according to claim 4 wherein the signal comprises a first signal, the method further comprising:
assigning the second module identifier to the second UPS system module to replace the temporary module identifier; and
transmitting a second signal from the second UPS system module to another UPS system module.

6. A method according to claim 5 wherein transmitting the requested module identifier information further comprises:
transmitting initialization information from the first UPS system module to the second UPS system module via the CAN to provide information for operations of the second UPS system module.

7. A method according to claim 5 wherein requesting module identifier information by the second UPS system module further comprises:
transmitting module information associated with the second UPS system module comprising module type, module revision, module software version, voltage meter values, frequency meter values, and/or power meter values to the first UPS system module via the CAN.

8. A method according to claim 7 further comprising:
defining a UPS system module map at the first UPS system module based on the module information received thereat.

9. A method according to claim 5 further comprising:
transmitting an acknowledgement from the second UPS system module to the first UPS system module to confirm assignment of second module identifier to second UPS system module.

10. A method according to claim 5 further comprising:
updating module identifier information at the first UPS system module to indicate assignment of second module identifier to second UPS system module.

11. A method according to claim 1 wherein the UPS system module identifiers comprise physical locations of UPS system modules associated therewith.

12. A method of assigning module identifiers in an Uninterruptible Power Supply (UPS) system comprising:
receiving a first signal at a first UPS module indicating availability of module identifier information from a second UPS module;
transmitting a Controller Area Network (CAN) message from the first UPS module to the second UPS module, requesting the module identifier information;
receiving a CAN message at the first UPS module from the second UPS module including the requested module identifier information;
assigning a module identifier to the first UPS module based on the received module identifier information; and
transmitting a second signal from the first UPS module indicating availability of modified module identifier information.

13. A method according to claim 12 wherein transmitting a CAN message from the first UPS module to the second UPS module comprises transmitting the CAN message including a temporary module identifier assigned to the first UPS system module responsive to receiving the first signal.

14. A method according to claim 13 wherein assigning a module identifier to the first UPS module based on the received module identifier information further comprises:
assigning the module identifier to the first UPS system module to replace the temporary module identifier.

15. A method according to claim 13 wherein receiving a CAN message at the first UPS module from the second UPS module including the requested module identifier information further comprises:
receiving initialization information from the second UPS system module to provide initial operating parameters to the first UPS system module.

16. A method according to claim 13 wherein transmitting a CAN message from the first UPS module to the second UPS module, requesting the module identifier information further comprises:
transmitting first UPS system module information comprising module type, module revision, module software version, voltage meter values, frequency meter values, and/or power meter values to the second UPS system module via the CAN.

17. A computer program product configured to carry out the method according to claim 13, comprising a computer readable medium having computer readable program code embodied therein.

18. Electronic signals transmitted via the CAN used to provide the method according to claim 13.

19. A circuit for communication among modules in an Uninterruptible Power Supply (UPS) system comprising:
a UPS system module assignment circuit included on a UPS system module, the circuit configured to receive a signal from outside the UPS system module indicating start of a UPS system module identifier assignment process; and
a Controller Area Network (CAN) interface circuit configured to transmit/receive CAN formatted messages including messages requesting module identifier information responsive to receipt of the signal.

20. A circuit according to claim 19 wherein the UPS system module assignment circuit further comprises:
an output circuit, responsive to the UPS system module assignment circuit and to the CAN interface circuit, wherein the output circuit is configured to transmit a

21. A circuit according to claim 19 wherein the signal is received outside the CAN formatted messages.

22. A circuit according to claim 19 further comprising:
a table configured to store temporary module identifier, initialization information comprising initial operating parameters for the UPS system module, a module identifier received from a master UPS system module via the CAN, a module version, and/or a software version number.

23. A circuit according to claim 19 wherein the UPS system module comprises a dummy UPS system module.

24. A circuit according to claim 19 further comprising:
a master UPS system module switch coupled to the UPS system module assignment circuit configured to indicate that the UPS system module comprises a master UPS system module configured to initiate UPS system module identification assignment procedures for other UPS system modules electrically coupled thereto.

25. A circuit according to claim 19 wherein the UPS system module comprises a master UPS system module, the circuit further comprising:
a table configured to store module identifier information comprising a plurality of module identifiers, and/or a UPS system module map including physical location information indicating respective positions of the UPS system modules assigned module identifiers.
